(19) United States
(12) Patent Application Publication
(10) Pub. No.: US 2018/0051670 A1
(43) Pub. Date: Feb. 22, 2018

(54) POWER GENERATING USING WIND

(71) Applicant: Subhash Omkarmal Agarwal, Ahmedabad (IN)

(72) Inventor: Subhash Omkarmal Agarwal, Ahmedabad (IN)

(21) Appl. No.: 15/567,120

(22) PCT Filed: Nov. 30, 2015
(86) PCT No.: PCT/IN2015/050181

§ 371 Date: Oct. 17, 2017

(51) Int. Cl. F03D 1/04; F03D 7/02

(52) U.S. Cl. CPC F03D 1/04; F03D 1/06; F03D 7/0204

(57) ABSTRACT

The present invented device is mounted on tower at seashore, desert or mountaintops. The device is mounted on the rotating stand, which is on the tower. As the air will be released into a long tunnel (tail), the device will automatically arrange in wind facing direction and the running air will continuously enter into the device. The entered inner part of the device has air collection chambers, so when the wind will get concentrated it will create air pressure. The pressured air will be released into a tunnel, where the turbine is mounted into the tail part to generate energy. And pressurized air will be released from the tail. The multiple device will be placed on high tower as high as a general windmill is mounted.

### FIELD OF THE INVENTION

The present invention relates POWER GENERATION USING WIND. In the present invention continuous energy is generated through wind. The main object of the present invention is to replace the windmill with present invented device to convert or directly utilize the wind energy to use to run the other device or to generate energy.

### BACKGROUND OF THE INVENTION

Recently, there has been a frequent occurrence of abnormal weather in association with global warming. Many glaciers in the Polar Regions have been reported to be melting due to global warming. It has been predicted that the abnormal weather will destroy or change the global ecosystem greatly. To maintain safe and life-friendly environments for future generations, it is necessary to prevent such environmental disruptions that are due to global warming. A main reason for global warming is thought to be the emission of a large amount of carbon dioxide into the atmosphere. This happens because, in modern civilization, energy is obtained mainly by burning fossil fuels such as coal and oil. To obtain energy while preventing global warming, accordingly, an energy source is needed which does not depend on conventional fossil fuels.

As such new energy sources, wind power and sunlight have been focused on. In consideration of this, wind power generation and solar power generation are being actively researched and developed in various countries.

In the meantime, to use generated electricity as a commercial power supply, inverters are required for wind power generation and solar power generation. However, wind power generation and solar power generation are adapted to different rated voltages, and hence a dedicated inverter has needed to be developed for each method of power generation. This causes delays in the release of newly developed wind power generators to the market and decreases the compatibility between wind power generators and solar power generators. Accordingly, ideas are needed for applying general purpose inverters to the generators and, in particular, to wind power generators.

In the existing to utilize wind power, windmills are mainly used to generate power and for that huge space is required to generate energy. Wherein in present invention is replace the existing wind mill and it the present invention multiple devices are connected in series and generating more power in less space area.

### OBJECT OF THE INVENTION

An object of the present invention is to provide a wind power generation apparatus to which general purpose inverters are applicable.

The main object of the invention is to generate more wind energy in less space area. Moreover in the present invention multiple devices are connected in series to generate energy.

The material to be used to make the present invented device is either plastic or synthetic fabric material, which is generally used in Hot Air Balloon or parachutes so, construction cost of the present invented device is very low compare to the existing wind mill.

The maintenance cost is very low so, the present invented device will generate energy continually without any maintenance for long time.

The present invented device is compact or easily assembled so the present invented device is easily transfer from one place to other.

The present invented device will automatically adjust according to wind facing direction so generate more power.

### BRIEF DESCRIPTION OF THE DRAWINGS

The structure and the technical means adopted by the present invention to achieve the above and other objectives, can be best understood by referring to the following detailed description of the preferred embodiments and the accompanying drawings, wherein

FIG. 1 represents the side view of the present invented device

FIG. 2 represents the multiple devices of the present invented device

### DETAILED DESCRIPTION OF THE INVENTION

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

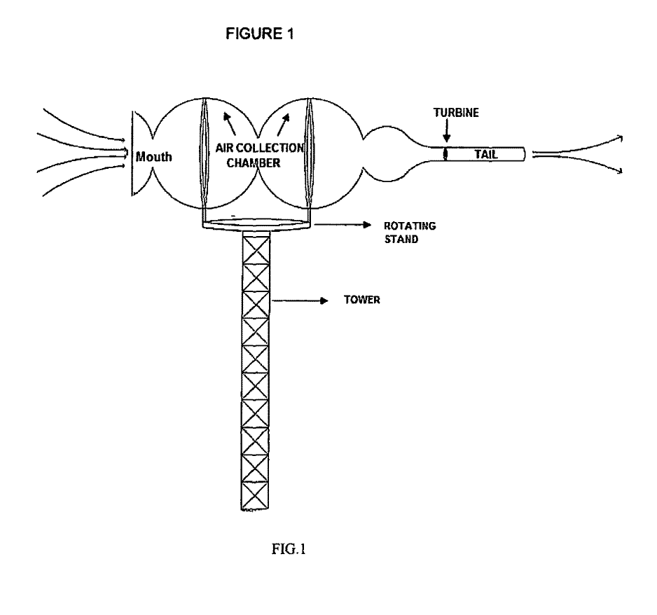

As show in FIG. 1, the present invented device is mounted on tower at seashore, desert or mountaintops. The device is mounted on the rotating stand, which is on the tower. As the air will be released into a long tunnel (tail), the device will automatically arrange in wind facing direction and the running air will continuously enter into the device. The entered inner part of the device has air collection chambers, so when the wind will get concentrated it will create air pressure. The pressured air will be released into a tunnel, where the turbine is mounted into the tail part to generate energy. And pressurized air will be released from the tail.

The device will be placed on high tower as high as a general windmill is mounted. The device will be mounted on the tower in such a way that it can easily turn it self in the direction of the wind like a wind cone (mostly put on the airport to show the wind speed and wind direction).

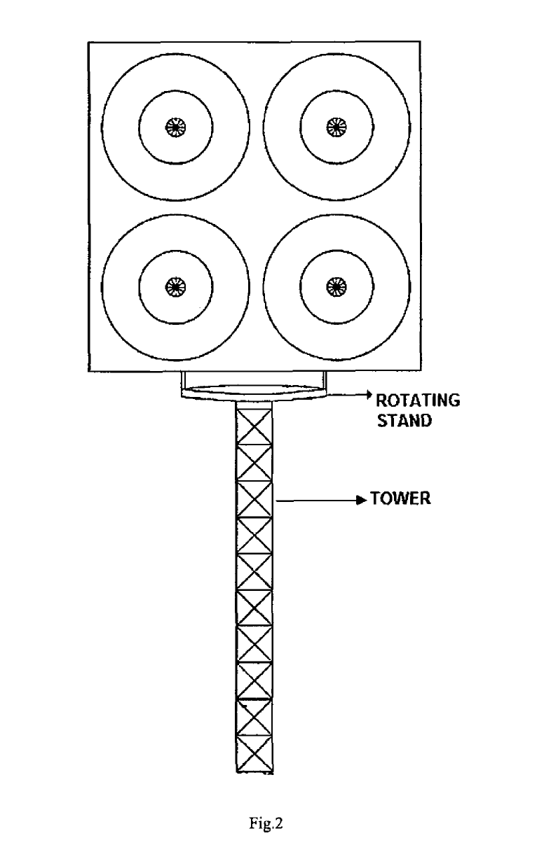

FIG. 2 shows these multiple devices can be put on the same tower so, multiple wind power can be obtained in the same space, so more power can be generated in same space than the existing windmill.

The present invented device is made either from the plastic or, synthetic fabric, which is generally used in hot air balloon or parachutes. This will make the device cheaper and easy to carry from one place to other.

Multiple devices can be put on one platform which, is an additional benefit of this device and is also cheaper and generates more power with less expenses.

For example: While facing wind, the open umbrella will always push you in the back ward direction. Similarly when a parachute or parasail comes in contact with facing wind, it pushes you backward and does not need to be pulled by a boat on the beach when the wind speed is high.

While, the invention has been described with respect to the given embodiment, it will be appreciated that many variations, modifications and other applications of the invention may be made. However, it is to be expressly understood that such modifications and adaptations are within the scope of the present invention, as set forth in the following claims.

I claim:

1. POWER GENERATION USING WIND comprising with wind collection chamber, tower, wind release long tunnel and turbine wherein the wind collection chamber is mounted on the rotating stand, which is on the tower
wherein the consented wind is release from the wind release long tunnel.

2. POWER GENERATION USING WIND as claimed in claim 1 wherein the inlet wind is collected at wind collection chamber which will be released into a long tunnel (tail), the device.

3. POWER GENERATION USING WIND as claimed in claim 1 wherein face of wind collection chamber is arrange in wind facing direction and the running air will continuously enter into the device.

4. POWER GENERATION USING WIND as claimed in claim 1 wherein the entered wind will get concentrated and will create air pressure in air collection chambers.

5. POWER GENERATION USING WIND as claimed in claim 1 wherein the pressured air will be released into a tunnel, where the turbine is mounted into the tail part to generate energy.

6. POWER GENERATION USING WIND as claimed in claim 1 wherein is made either from the plastic or, synthetic fabric.

7. POWER GENERATION USING WIND as claimed in claim 1 wherein multiple devices can be put on the same tower so, multiple wind power can be obtained in the same space.
